(19) United States
(12) Patent Application Publication
(10) Pub. No.: US 2023/0148565 A1
(43) Pub. Date: May 18, 2023

(54) FEEDLOT FEEDING CONTROL SYSTEM APPARATUS AND METHOD

(71) Applicant: Lynn Mayer, Pukwana, SD (US)

(72) Inventor: Lynn Mayer, Pukwana, SD (US)

(21) Appl. No.: 17/988,901

(22) Filed: Nov. 17, 2022

Related U.S. Application Data
(60) Provisional application No. 63/280,297, filed on Nov. 17, 2021.

(51) Int. Cl. A01K 5/02

(52) U.S. Cl. CPC A01K 5/0275

(57) ABSTRACT

A control system dispenses an optimal amount of feed so that it is substantially evenly distributed along the length of the bunker in a feed lot. The control system can include a feedback loop. The control system controls a dispenser, such as an auger or a door actuator to dispense feed. A method for controlling is also discussed. The method can be formed as an instruction set that causes a processor to implement the method.

### PRIORITY CLAIM

This application claims the benefit of U.S. Provisional Patent Application No. 63/280,297 filed Nov. 17, 2021, the entire disclosure of which is hereby incorporated by reference.

### BACKGROUND AND ENVIRONMENT

A feedlots or feed yard is a type of animal feeding operation where animals are confined to an area and fed to prepare the animals being fed for market. The most common type of feedlot or feed yard is for cattle. Other animals can also be fed in a similar way such as swine, sheep, chicken or turkeys. The animals are fed a controlled formula such as silage with various nutrients. The basic premise of a feedlot is to increase the amount of fat gained by each animal as quickly as possible. The animals are placed in a confined area so as to limit the amount of fat burned, as compared to free range animals, such as free-range cattle which are allowed to roam and forage for food over a much larger area. Typically, cattle are allowed to feed on grass found in much larger fields. The farmer or rancher provides watering stations in some free-range operations.

Of course, agricultural professionals seek to maximize profits for their operations. In many feedlots, animal feed is placed in bunkers and cattle in the lot come to the bunkers to eat. The bunker is a long feed trough. Cattle are creatures of habit and typically come to the same spot on a bunker for each meal. In many instances, a feed wagon that contains the feed is driven beside the bunker. Feed from the feed wagon is distributed in the bunker by some means of conveyance. The wagon may be use gravity to move the feed and a door on the side of the wagon is controllably opened to place feed into the bunker. Other conveyors or augers can also be used to move the feed from the feed wagon into the bunker. Most of the time, the wagon is pulled by a tractor and the tractor operator must control the conveyance of the feed. In many instances, the operator is distributing feed based on visual information as it falls into the bunker. Most of the time, the feed is not distributed evenly in the bunker resulting in overfeeding or underfeeding the animals in the feed lot. Generally, there is an optimal amount of feed for the animals. The challenge, among other challenges, is to get an optimal amount of feed to each of the cattle in the feed lot.

### SUMMARY OF THE INVENTION

An innovative solution is used to dispense an optimal amount of feed so that it is substantially evenly distributed along the length of the bunker in a feed lot. The velocity of the feed wagon is determined with respect to the bunker. In one embodiment, the ground speed of a feed wagon is determined using a speedometer. In another embodiment, a GPS sensor is used to periodically determine the change in position of the feed wagon over a time period. The speed can be determined from the change in position divided by the time between positions. Speed can be determined. The ground speed is input to a controller which controls the conveyance from the feed wagon to the bunker or feed trough. At greater ground speeds, the conveyance outputs more feed into the bunker. At slower speeds the conveyance outputs less feed into the bunker. The controller is used to control the rate of feed output from the feed wagon. In some embodiments, a uniform amount of feed is placed into the bunker along a set length of the bunker. In another embodiment, some portions of the bunker may not need as much feed since not as many cattle feed along a particular stretch of bunker. In this embodiment, the amount to feed distributed to the lees used portion of the bunker can be less. In still other embodiments, a feedback control loop can be used. In one embodiment, a camera can be used to determine a volume of feed in the bunker at any time. In another embodiment, the feed wagon can be provided with strain gauges that act as a scale so that the weight of the feed dispensed over a length of time can be used to determine the amount of feed dispensed to the bunker.

In this way the feed can be distributed into a bunker so that each of the cattle is most likely to get just about the right amount or optimal amount of feed. Cattle feed is not wasted. The feed expense is minimized as when an optimal or near optimal amount of cattle feed is dispensed, the cattle grow quickly so that the time to market is minimized, and the amount of feed needed to “feed out” the cattle is also minimized.

### BRIEF DESCRIPTION OF THE DRAWINGS

FIG. 1 is a schematic of a feed lot that includes a bunker, according to an example embodiment.

FIG. 2 shows a feed wagon and conveyance for placing feed into a bunk, according to an example embodiment.

FIG. 3 is a schematic view of a feed wagon and conveyance, according to an example embodiment.

FIG. 4A is a schematic showing components of a generic control system which can be associated with the feed wagon, according to an example embodiment.

FIG. 4B is a schematic showing a generic control system that includes a feedback control input, according to another example embodiment.

FIG. 5 is a diagrammatic representation of one control system 500, according to an example embodiment.

FIG. 6 is a method for distributing feed into a receptacle, such as a bunk, according to an example embodiment.

FIG. 7 shows a diagrammatic representation of a control system that includes a feedback control loop, according to an example embodiment.

FIG. 8 shows a diagrammatic representation of a computing device for a machine in the example electronic form of a computer system, according to an example embodiment.

FIG. 9 is a schematic drawing of a machine readable medium that includes an instruction set, according to an example embodiment.

### DETAILED DESCRIPTION OF THE INVENTION

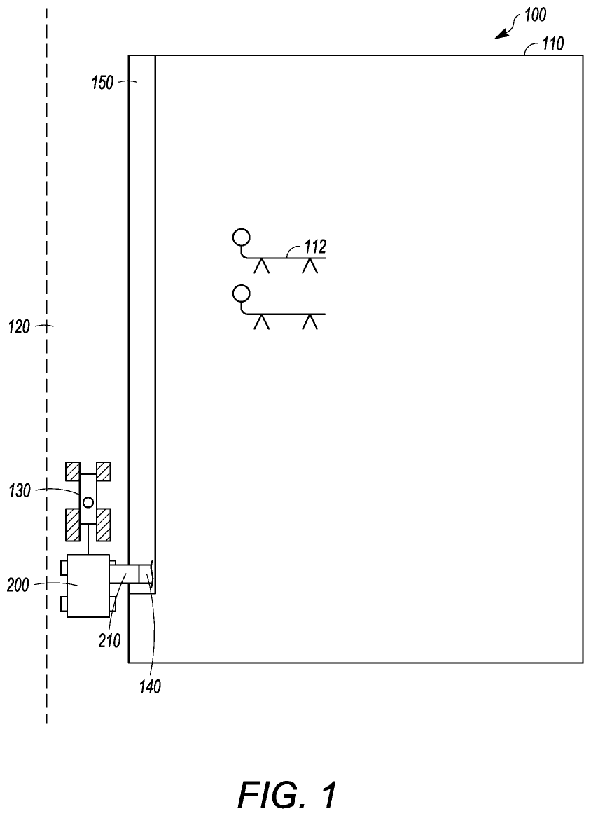

FIG. 1 is a schematic of a feed lot 100 that includes a bunker 150, according to an example embodiment. The feed lot 100 includes a fenced in area 110 for containing livestock 112, such cattle, pigs, turkeys, or the like. In some embodiments, the fenced in area could be a containment barn which is essentially a large covered fenced in area. Some containment barns include a pit for capturing manure. The livestock 112 are supported by a slotted floor atop the pit. The feed lot 100 also includes a path or road 120 adjacent the bunker 150. A feed wagon 200 is pulled by a tractor 130 along the path 120. A delivery chute 210 delivers feed 140 into the bunker 150. The feed wagon 200 dispenses feed 140 as the feed wagon 200 is pulled down the path 120. The feed 140 is mixed and placed into the feed wagon 200. Nutrients and other additives are added to the feed 140. The feed can be mixed per a software feeding program such as Performance Beef: Cattle Management Software which is available from Performance Livestock Analytics of Ames, Iowa USA. Performance Beef, according to Performance Livestock Analytics, is as an easy-to-use, cloud-based technology that integrates feed, financial and health information in one easy-to-use platform, accessible from anywhere.

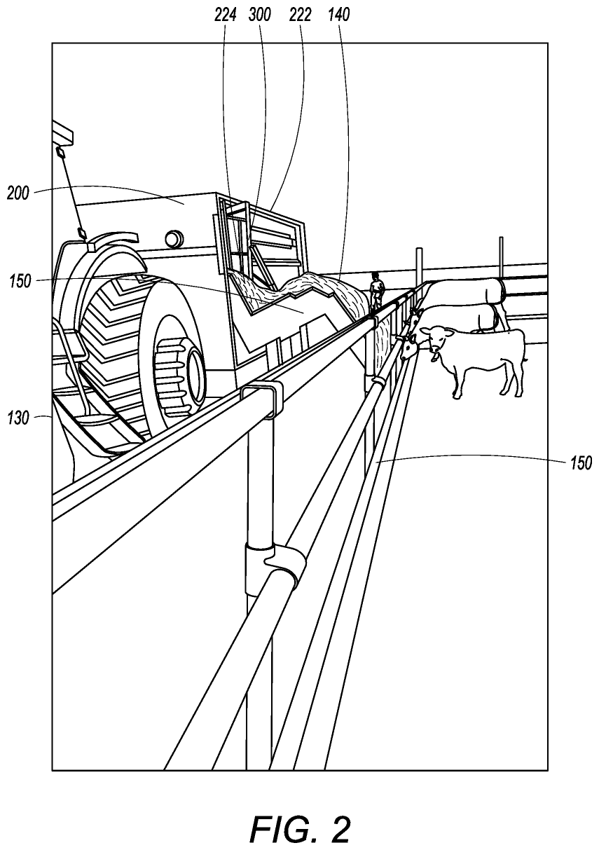

FIG. 2 shows a feed wagon 200 and conveyance 220 for placing feed into a bunk 150, according to an example embodiment. The feed wagon includes a mechanism or mechanisms which are under control of a software instruction set. The feed wagon 200, shown includes a hopper 222. A hopper 222 is a box having inclined sides which terminate near the bottom of the hopper 222. A gate 224 is positioned at or near the bottom of the hopper 222. In the embodiment shown in FIG. 2, the feed wagon 200 is dispensed by way of gravity. By opening a door or gate 222 a little way, a small amount of feed is dispensed from the hopper 222 through the gate 224 and to the chute 210 (see FIG. 1) and into the bunk 150 (See FIG. 1). Opening the gate 224 more will increase the amount of the feed that will pass out of the gate 224, to the chute 210 and into the bunker 150.

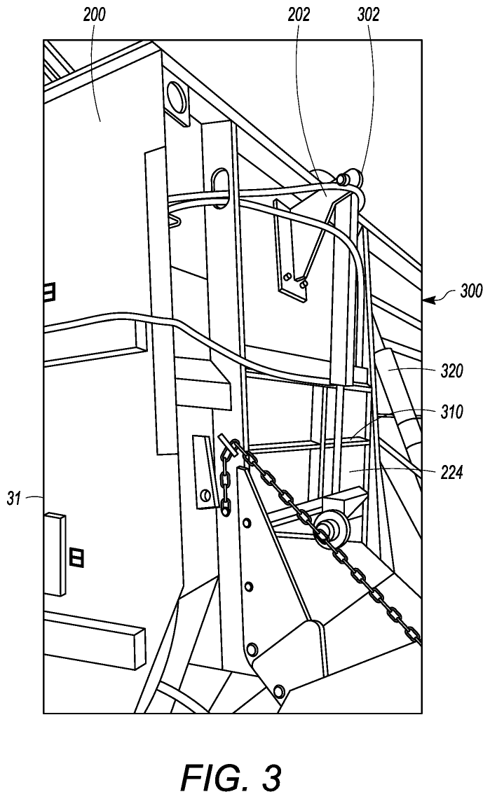

An electric hydraulic directional control valve 300 is attached to the gate 224. This is shown in FIG. 2 but is more clearly shown in FIG. 3. FIG. 3 is a isometric view of a feed wagon 200 and the gate 300, according to an example embodiment. The hydraulic directional control valve 300 includes a first end 301 and a second end 302. The hydraulic directional control valve 300 includes a main body 320. An actuator shaft 310 is movably attached to the main body 320. The actuator shaft 310 moves with respect to the first end 301 of the hydraulic directional control valve 300. The free end of the actuator shaft 310 is attached to a door or gate 224 of the feed wagon 200. The second end 302 of the hydraulic directional control valve 300 is attached to a stationary point 202 on the feed wagon 200. The electric hydraulic directional control valve 300 is controllable to move the actuator shaft 310 to open the gate 224 or close the gate 224. Of course, the actuator shaft can be stopped anywhere along the path between the gate open or closed positions to partially open or close the gate 224 of the feed wagon. The amount of feed coming out of the gate 224 of the feed wagon 200 will depend on how far open the gate 224 of the feed wagon 200 is open and on the amount of feed in the wagon. The embodiment described herein is for a gravity wagon and so if the wagon is fuller, the feed will be forced out at a greater rate than when the feed wagon is half full.

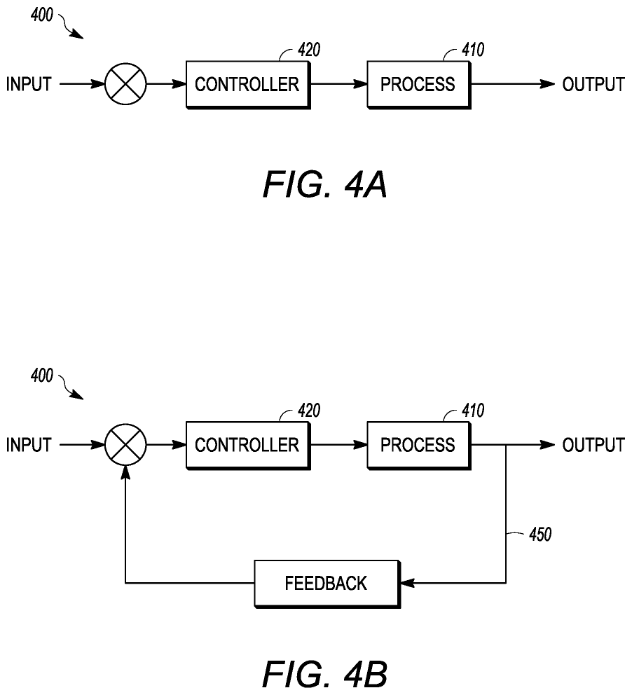

FIG. 4A is a schematic showing components of a generic control system 400 which can be associated with the feed wagon 200, according to an example embodiment. FIG.4A shows an open loop type of control system. The output is not measured. Rather the control includes inputs which are fed to a processor 410 and controller 420. The controller 420 operates the machinery or other apparatus to distribute feed to the feed trough or bunk 150. The controller in this case would be the electric hydraulic directional control 300 (shown in FIGS. 2 and 3) which controls the door 224. A simple example would be that the controller opens the door more with increased speed of the feed wagon so that an equal amount flows into the bunk 150.

FIG. 4B is a schematic showing a generic control system 400′ that includes a feedback control input 450. The components of the system 400′ are the same as the control system 400. The control system 400′ includes the feedback control loop or input. The output or amount of feed actually placed in the bunk is measured. In other words, the calculated output of the system is measured against actual. If it differs then the processor and controller can make further adjustments to make the actual substantially match the calculated or desired output. In both embodiments, the electric hydraulic directional control valve 300 is part of a control system 400 where a set of instructions, such as those associated with computer software, are used to control the amount of feed dispensed from the feed wagon 200 to the bunk 150. One goal of the invention is to have a substantially uniform distribution of feed along a length of the bunk 150.

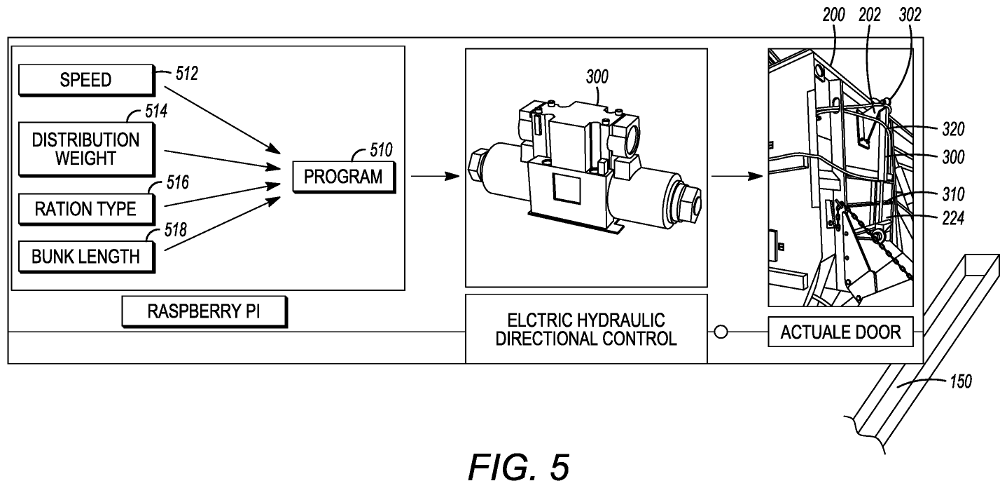

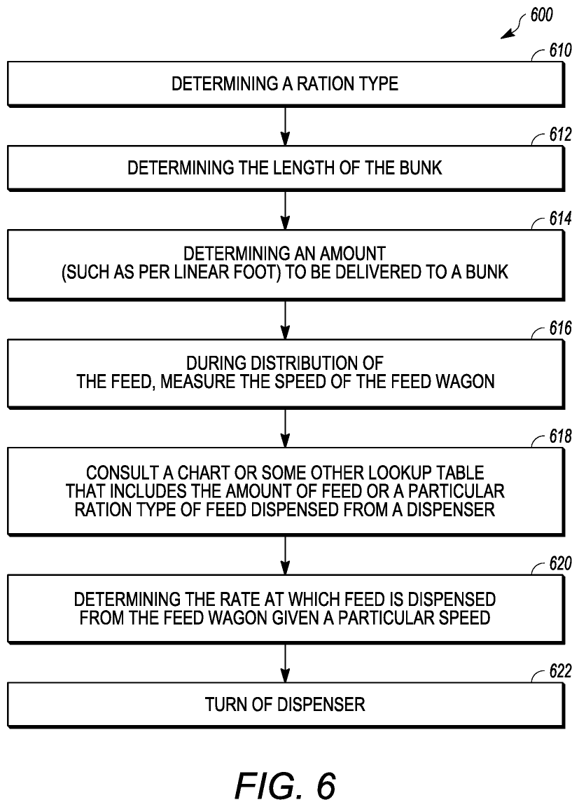

FIG. 5 is a diagrammatic representation of one control system 500, according to an example embodiment. In this particular embodiment, there is no feedback control loop. In other words, the type of control used is that depicted in FIG. 4A. The instructions distribute the feed in the wagon without monitoring the output A computer program 510 controls the hydraulic directional control valve 300 which in turn controls the position of the door or gate 224 to vary the size of the opening through which the feed 140 will pass to the chute 210 and into the bunk 150. Inputs to the computer program 510 include the speed of the feed wagon 512, the distribution weight 514, the bunk length 518 and the ration type 516. The distribution weight 514 is the weight of the feed to be output to a portion of bunk. Certain ration types 516 will have different weights or densities and the amount going into the bunk in terms of weight will vary. The set of instructions or computer program 510 will implement a method 600 which is set forth in FIG. 6.

FIG. 6 is a method 600 for distributing feed into a receptacle, such as a bunk, according to an example embodiment. The method 600 includes determining a ration type 610 and determining the length of the bunk 612. The length of the bunk 612 does not have to be the entire length. For example, feed may be delivered along only a short length of a bunk if the herd is small, such as after selling off a portion of the herd. The ration type is used to determine an amount (such as per linear foot) that has to be delivered to a bunk 614. The amount delivered, in one embodiment, can be the weight delivered per linear foot. The amount delivered can also be based on the number of animals in the herd. For example, each animal may be fed X amount to be considered full. There may be a percentage of X that can be delivered to the bunk that is the optimal amount per herd member. For example, in one embodiment, the amount is X (0.92) according to some studies. The total amount of weight can be determined using either of these criteria. This can be termed the distribution weight which of course may change with a change in the ration type. During distribution of the feed, the speed of the feed wagon is measured 616. For example, the speed may be in terms of feet per second or feet per minute. A feed wagon traveling at 1 mph would be going about 1.46 feet/second. A chart or some other lookup table that includes the amount of feed or a particular ration type of feed is consulted by the instructions 618. The chart could include the amount of feed dispensed per second for a given size gate opening in the feed wagon. Alternatively, a look up chart might be for an amount of feed dispensed by one revolution of an auger. An auger would be used in other types of feed wagons. The method would further include determining the rate at which feed is dispensed from the feed wagon given a particular speed 620. Finally, from the speed of the feed wagon and the time of travel the length of travel of the feed wagon could be determined. When the length of travel equals the length of the trough then the dispensing mechanism can be turned off 622. Dispensing control system 500 has no feedback. Dispensing would begin when proximate the trough 150 and end after the appropriate amount of feed has been dispensed over the desired length or when the feed is dispensed from the feed wagon. The start and end of the trough or bunk 150 length could be marked by some sort of proximity sensor, visual indicator or the like.

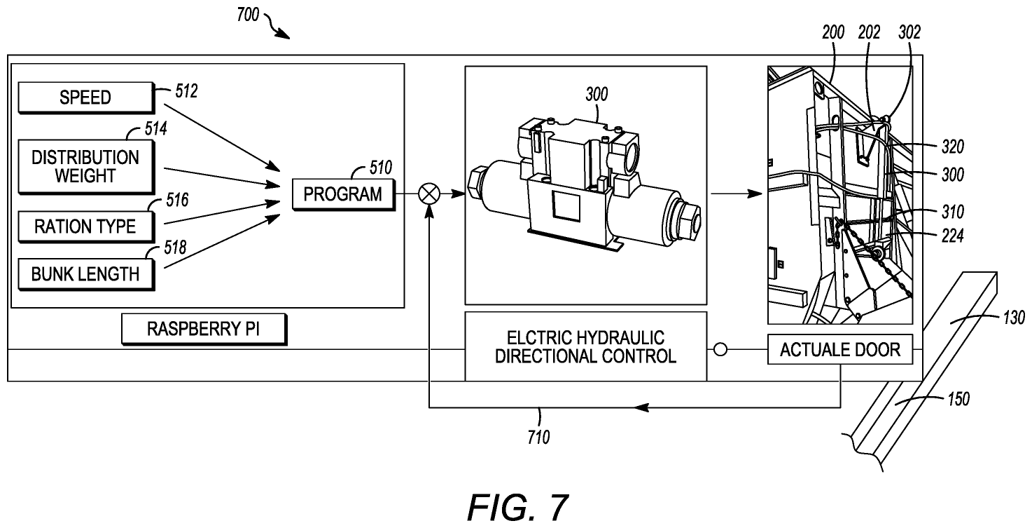

FIG. 7 shows a diagrammatic representation of a control system 700 that includes a feedback control loop 710, according to an example embodiment. The control system 700 also includes a summer 720 that receives the output from the program and compares it to the actual output, such as the feed 730 in the bunk 150. The actual information regarding the actual output 730 is also used as another program input. The other inputs to the feedback control system 700 include the same as the inputs to the control system 500. In other words, the inputs include the speed of the feed wagon 512, the distribution weight 514, the bunk length 518 and the ration type 516. The distribution weight 514 is the weight of the feed to be output to a portion of bunk. Certain ration types 516 will have different weights or densities and the amount going into the bunk in terms of weight will vary. The final input is the feed back signal. This signal is indicative of the actual output, which in this case would be the amount of feed actually delivered to the bunk 150. This is compared to the target amount of feed to be delivered to the bunk 150 and the variance is used to vary a control portion, such as the hydraulic cylinder which opens or closes the gate on the feed wagon. The gate will open more to deliver more if it is determined that the actual amount delivered was less than the desired or target amount. The gate will be closed more in the event that the actual amount of feed exceeded the target amount of feed delivered to the bunk 150. It should be understood that the above embodiments deal with a gravity type feed wagon. It is fully contemplated that other types of wagons for delivering feed with different types of feed delivery conveyances could also be used. It is contemplated that the above control methods are equally applicable to other types of feed wagons.

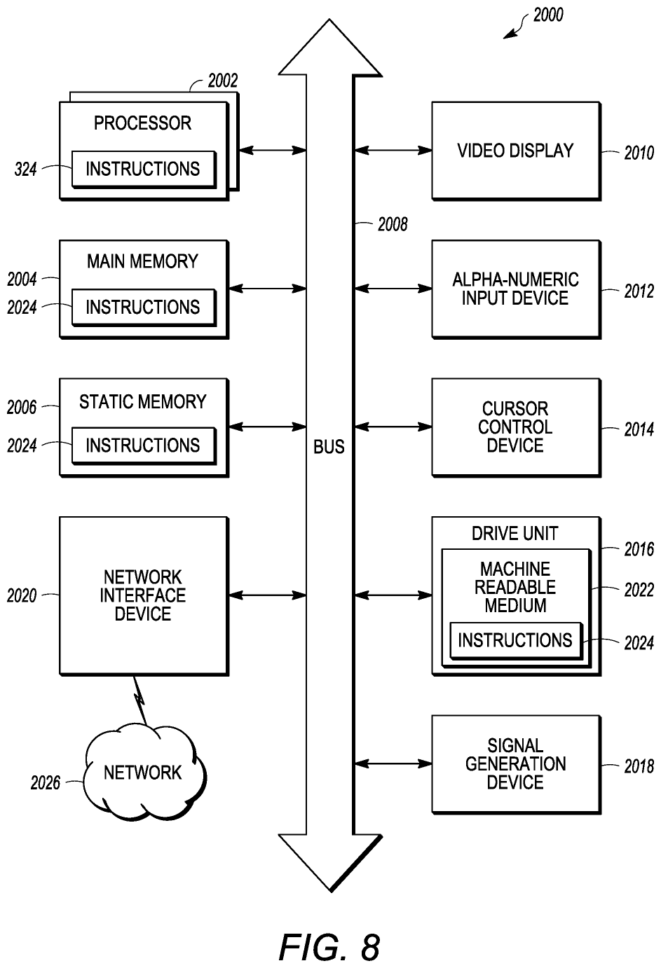

FIG. 8 shows a diagrammatic representation of a computing device for a machine in the example electronic form of a computer system 2000, within which a set of instructions for causing the machine to perform any one or more of the methodologies discussed herein can be executed or is adapted to include the apparatus for a feedlot and the like as well as a method for feeding as described herein. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a portable music player (e.g., a portable hard drive audio device such as a Moving Picture Experts Group Audio Layer 3 (MP3) player, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor or multiple processors 2002 (e.g., a central processing unit (CPU), a graphics processing unit (GPU), arithmetic logic unit or all), and a main memory 2004 and a static memory 2006, which communicate with each other via a bus 2008. The computer system 2000 can further include a video display unit 2010 (e.g., a liquid crystal display (LCD) or a cathode ray tube (CRT)). The computer system 2000 also includes an alphanumeric input device 2012 (e.g., a keyboard), a cursor control device 2014 (e.g., a mouse), a disk drive unit 2016, a signal generation device 2018 (e.g., a speaker) and a network interface device 2020.

The disk drive unit 2016 includes a computer-readable medium 2022 on which is stored one or more sets of instructions and data structures (e.g., instructions 2024) embodying or utilized by any one or more of the methodologies or functions described herein. The instructions 2024 can also reside, completely or at least partially, within the main memory 2004 and/or within the processors 2002 during execution thereof by the computer system 2000. The main memory 2004 and the processors 2002 also constitute machine-readable media.

The instructions 2024 can further be transmitted or received over a network 2026 via the network interface device 2020 utilizing any one of a number of well-known transfer protocols (e.g., Hyper Text Transfer Protocol (HTTP), CAN, Serial, or Modbus).

While the computer-readable medium 2022 is shown in an example embodiment to be a single medium, the term “computer-readable medium” should be taken to include a single medium or multiple media (e.g., a centralized or distributed database, and/or associated caches and servers) that store the one or more sets of instructions and provide the instructions in a computer readable form. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, tangible forms and signals that can be read or sensed by a computer. Such media can also include, without limitation, hard disks, floppy disks, flash memory cards, digital video disks, random access memory (RAMs), read only memory (ROMs), and the like.

In one embodiment a raspberry pi computing device is used to control the output of feed into a bunk or a method of feeding associated with the above described inventions. The raspberry pi computing device is available from Raspberry Pi (Trading) Limited with a registered office at Maurice Wilkes Building, St. John's Innovation Park, Cowley Road, Cambridge, CB4 ODS. Other computing devices can be used to implement the above invention. It is contemplated that a smart phone could be used to implement the above invention. In one embodiment, the smartphone runs a software ap or application. In this another embodiment, the above invention is incorporated into analytic software for livestock such as PERFORMANCE BEEF which is available from Cattle Krush of Ames, Iowa.

The example embodiments described herein can be implemented in an operating environment comprising computer-executable instructions (e.g., software) installed on a computer, in hardware, or in a combination of software and hardware. Modules as used herein can be hardware or hardware including circuitry to execute instructions. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method(s) can be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

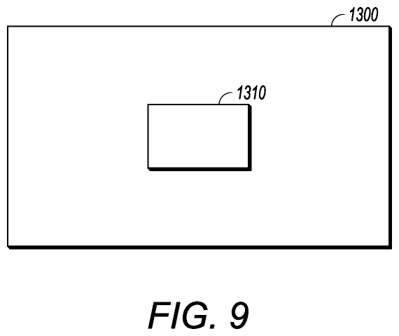

FIG. 9 is a schematic drawing of a machine readable medium 1300 that includes an instruction set 1310, according to an example embodiment. The machine-readable medium 1300 that provides instructions 1310 that, when executed by a machine, cause the machine to perform operations including the invention described with respect to FIG. 6. The media 1300 carries a set of non-transient instructions 1310 for causing a processor associated with a computer system to perform the method shown in FIG. 6.

The present disclosure refers to instructions that are received at a memory system. Instructions can include an operational command, e.g., read, write, erase, refresh, etc.; an address at which an operational command should be performed; and the data, if any, associated with a command. The instructions can also include error correction data.

It should be noted that the computer system 20000 can be any type of computer such as a laptop computer, notebook computer, desktop computer, point of sale terminal, enterprise system, a smartphone or other smart device.

In summary, disclosed is a method for monitoring and controlling the amount of feed distributed into a bunk. The method for monitoring and controlling the amount of feed distributed into a bunk includes determining the length of the bunk where feed needs to be placed and determining an amount of feed that needs to be placed in a bunk. The method further includes moving a feed wagon containing feed along the length of the bunk. The feed wagon includes a container for feed, and a controllable feed dispensing mechanism for placing feed into the bunk at various rates. The method also includes determining the speed at which the feed wagon is moving with respect to the bunk, and controlling the rate of dispensing the feed so that the determined amount of feed needed to be placed in the bunk is distributed over the determined length of the bunk. In some embodiments, a global positioning system is used to determine the speed of the feed wagon containing the feed. In other embodiments, a speedometer, such as one on a tractor or other moving conveyance can be used to determine speed. In still further embodiments, the bunk includes at least two markers, of any type. These could be RFID tags, the distance between the at least two markers and the time between the two markers used to determine speed. In some embodiments, blue tooth devices can be used to measure speed. The method, in some embodiments, includes monitoring the amount of feed being distributed. In other words, the amount of feed actually being distributed is monitored. In some cases, a scale associated with the container for holding feed is monitored for weight loss over an amount of time. In one embodiment, the container includes a strain gauge. The varying output from the strain gauge is equated to a weight difference. Monitoring the amount of feed being distributed includes reading on output from the strain gauge. In still a further embodiment, monitoring the amount of feed includes a camera which measures the volume of feed output from the container or placed into the bunker or feed trough for a selected amount of time. In still further embodiments, a measured value of the amount of feed output from the container for an amount of time is used as an input for controlling the rate of dispensing feed. The measured value is compared to a determined or desired value. The difference between the two is used to correct the amount of feed being dispensed. In one embodiment, controlling the rate of dispensing the feed includes controlling a gate on an opening in the container to control the rate the feed moves out of the container. In another embodiment, controlling the rate of dispensing the feed includes controlling the speed of an auger having an input end within the container and an output end near the bunker. Determining an amount of feed includes determining a ration type to be distributed to livestock.

The above method can be formed into a set of instructions that cause a computer to perform the method.

It is also contemplated that the invention can be to a media carrying the set of instructions. So, among the embodiments is a media carrying a set of non-transient instructions for causing a processor associated with a computer system to perform a method including determining a select amount of feed to be placed in a bunk, and determining the speed at which the feed wagon is moving with respect to the bunk, and controlling the rate of dispensing the feed from a moving container so that the determined amount of feed needed to be placed in the bunk is distributed over the determined length of the bunk. In another embodiment, the set of non-transient instructions for causes the processor associated with a computer system to measure an amount of feed actually placed in a bunk, compare the amount placed in the bunk to the select amount of feed determined to be placed in the bunk, and produce a control signal for increasing the rate or decreasing the rate of feed being placed in a bunk based on the difference between the measured amount of feed and the determined amount of feed to be placed in the bunk.

An apparatus for monitoring and controlling the amount of feed distributed into a bunk includes a container for holding a ration of feed, a mover for moving a container along a feed trough, and a speedometer for determining the speed of the container. The apparatus also includes a mechanism for controllably moving feed from the container to a feed trough near the container. The feed dispensing apparatus further includes an apparatus for controlling the rate feed is dispensed from the feed dispensing apparatus. The feed dispening apparatus includes a processor, and a storage device communicatively coupled to the processor, the processor. The processor can be used to determine an amount of feed that needs to be placed in the feed trough for a given length of the feed trough. The processor can also control the feed dispensing apparatus to place the determined amount of feed in the feed trough for the given length of the feed trough. The feeding apparatus can also include a monitor associated with the feeding apparatus for determining an amount of feed actually dispensed. The monitor can output a measure of an amount of feed being dispensed. The feeding apparatus can also include a comparator for comparing the measure of the amount of feed being dispensed to the determined amount of feed to dispense. If there is a difference between the two amounts, the difference can be used to control a rate at which the feed is being dispensed from the feed dispensing system. Of course, the control is used to move the actual amount dispensed closer to the determined or selected amount of feed that is desired to be dispensed. The feed dispensing apparatus, for moving feed from the container to a feed trough near the container includes further includes a slanted floor, a door in the container near the lower part of the slanted floor, and a hydraulic ram positioned to controllably open the door near the lower part of the slanted floor to control an amount of feed being dispensed from the container the hydraulic ram opens the door wider when additional feed is to be dispensed and partially closes the door when less feed has to be dispensed. The feed dispensing apparatus, for moving feed from the container to a feed trough near the container may also include an auger with a spiral shaped blade on a shaft. The shaft is turned faster when more feed needs to be dispensed or slower when less feed needs to be dispensed.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment.

These embodiments are described in sufficient detail to enable those of ordinary skill in the art to understand and implement the inventive subject matter. Other embodiments may be utilized, and changes may be made without departing from the scope of the inventive subject matter. Thus, although specific embodiments have been illustrated and described herein, any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art upon reviewing the above description.

What is claimed is:

1. A method for monitoring and controlling the amount of feed distributed into a bunk comprising:
determining the length of the bunk where feed needs to be placed;
determining an amount of feed that needs to be placed in a bunk;
moving a feed wagon containing feed along the length of the bunk, the feed wagon further comprising:
a container for feed; and
a controllable feed dispensing mechanism for placing feed into the bunk at various rates;
determining the speed at which the feed wagon is moving with respect to the bunk;
controlling the rate of dispensing the feed so that the determined amount of feed needed to be placed in the bunk is distributed over the determined length of the bunk.

2. The method of claim 1 wherein determining the speed is measured using a global positioning system.

3. The method of claim 1 wherein determining the speed is measured using a speedometer.

4. The method of claim 1 wherein the bunk includes at least two markers, the distance between the at least two markers and the time between the two markers used to determine speed.

5. The method of claim 1 further comprising monitoring the amount of feed being distributed.

6. The method of claim 5 wherein the container includes a scale associated with the container for holding feed.

7. The method of claim 5 wherein the container is provided with a strain gauge, wherein montitoring the amount of feed being distributed includes reading on output from the strain guage.

8. The method of claim 5 wherein monitoring the amount of feed includes a camera which measures the volume of feed output from the container for a selected amount of time.

9. The method of claim 5 further comprising using a measured value of the amount of feed output from the container for an amount of time is used as an input for controlling the rate of dispensing feed, the measured value compared to a desired value, the difference used to correct the amount of feed being dispensed.

10. The method of claim 1 wherein controlling the rate of dispensing the feed includes controlling a gate on an opening in the container to control the rate the feed moves out of the container.

11. The method of claim 1 wherein controlling the rate of dispensing the feed includes controlling the speed of an auger having an input end within the container.

12. The method of claim 1 wherein determining an amount of feed includes determining a ration type to be distributed to livestock.

13. A feeding apparatus for livestock comprising:
a container for holding feed;
a conveyance for moving the container;
a speedometer for determining the speed of the container;
a feed dispensing apparatus, for moving feed from the container to a feed trough near the container, the feed dispensing apparatus further comprising an apparatus for controlling the rate feed is dispensed from the feed dispensing apparatus;
a processor;
a storage device communicatively coupled to the processor, the processor
determining an amount of feed that needs to be placed in the feed trough for a given length of the feed trough; and
controlling the feed dispensing apparatus to place the determined amount of feed in the feed trough for the given length of the feed trough.

14. The feeding apparatus of claim 14 further comprising a monitor associated with the feeding apparatus for determining an amount of feed being dispensed.

15. The feeding apparatus of claim 14 further comprising:
a monitor associated with the feeding apparatus for outputting a measure of an amount of feed being dispensed; and
a comparator for comparing the measure of the amount of feed being dispensed to the determined amount of feed to dispense and using the difference between the two amounts to control a rate at which the feed is being dispensed from the feed dispensing system.

16. The feeding apparatus of claim 14 wherein the feed dispensing apparatus, for moving feed from the container to a feed trough near the container includes further comprises:
a slanted floor;
a door near the lower part of the slanted floor;
a hydraulic ram positioned to controllably open the door near the lower part of the slanted floor to control an amount of feed being dispensed from the container, the hydraulic ram opening the door wider when additional feed is to be dispensed and partially closing the door when less feed has to be dispensed.

17. The feeding apparatus of claim 14 wherein the feed dispensing apparatus, for moving feed from the container to a feed trough near the container includes further includes an auger with a spiral shaped blade on a shaft, the shaft turned faster when more feed needs to be dispensed or slower when less feed needs to be dispensed.

18. A media carrying a set of non-transient instructions for causing a processor associated with a computer system to perform a method comprising:
determining a select amount of feed to be placed in a bunk;
determining the speed at which the feed wagon is moving with respect to the bunk;
controlling the rate of dispensing the feed from a moving container so that the determined amount of feed needed to be placed in the bunk is distributed over the determined length of the bunk.

19. The media carrying a set of non-transient instructions for causing a processor associated with a computer system to perform a method of claim 19 further comprising
measuring an amount of feed actually placed in a bunk;
comparing the amount placed in the bunk to the select amount of feed determined to be placed in the bunk; and
producing a control signal for increasing the rate or decreasing the rate of feed being placed in a bunk based on the difference between the measured amount of feed and the determined amount of feed to be placed in the bunk.
